(19) United States
(12) Patent Application Publication
(10) Pub. No.: US 2019/0249848 A1
(43) Pub. Date: Aug. 15, 2019

(54) ENCLOSURE FOR A LIGHTING DEVICE INSERT

(71) Applicants: Steven Gramling, Redondo Beach, CA (US); Carleton Ruthling, Torrance, CA (US)

(72) Inventors: Steven Gramling, Redondo Beach, CA (US); Carleton Ruthling, Torrance, CA (US)

(21) Appl. No.: 15/381,563

(22) Filed: Dec. 16, 2016

(51) Int. Cl. F21V 15/01; F21V 17/12; F21V 21/32

(52) U.S. Cl. CPC F21V 15/01; F21Y 2115/10; F21V 21/32; F21V 17/12

(57) ABSTRACT

Disclosed is an enclosure for a lighting device insert. The enclosure for a lighting device insert comprises of a body component to accommodate the lighting device insert therein, a foldable tail component to mount the enclosure on a vehicle body, and a securing component to secure the lighting device insert and the foldable tail component therein.

### FIELD OF THE INVENTION

The present application generally relates to the field of a lighting device fixture for vehicles. Particularly, the application provides an enclosure for a lighting device insert.

### BACKGROUND

Recent time has witnessed tremendous growth and development in smart ecofriendly mobility solutions, such as bicycles, small battery operated scooters etc. While development of any such ecofriendly mobility solutions, illumination or lighting is always considered as one of the important focus area.

Prior art literature illustrates a variety of integrated lighting solution for such mobility solutions. However, due to certain technical problem there has been an increased use of retrofitted lighting device insert. A typical retrofitted lighting device inserts may include LEDs, circuit board and battery covered in silicon covering that can be attached to a bicycle or other mobility solutions. However, prior art solution providing retrofitted lighting device inserts may have certain challenges such as the silicon covering may be easily removed and would not prevent the exposure of the circuit board, LEDs and batteries to the external environment. Any such exposure could eventually pose lead hazard, or choking hazard for user or damage to the lighting device inserts itself.

In view of the above mentioned background, it is evident that, there is a need for an enclosure for a lighting device insert, which prevents the exposure of the circuit board, LEDs and batteries to the external environment. Further, there exists a need for an enclosure for a lighting device insert, which could prevent potential lead hazard, or choking hazard for user or damage to the lighting device inserts itself. An enclosure for a lighting device insert is desired.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide an enclosure for a lighting device insert.

Another objective is to provide an enclosure for a lighting device insert which prevents the exposure of the circuit board, LEDs and batteries to the external environment.

Another objective of the present invention is to provide an enclosure for a lighting device insert to prevent potential lead hazard, or choking hazard for user or damage to the lighting device itself.

In accordance with one embodiment of the present invention, an enclosure (100) for a lighting device insert is provided. The enclosure (100) for the lighting device insert comprises of a body component (102) to accommodate the lighting device insert therein; a foldable tail component (104) to mount the enclosure (100) on a vehicle body; and a securing component (106) to secure the lighting device insert and the foldable tail component (104) therein.

The above configuration is provided for an enclosure for a lighting device insert but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 is a diagram illustrating top external view of an open enclosure for a lighting device insert, in accordance with one embodiment of the present invention;

FIG. 2 is a diagram illustrating top internal view of an open enclosure for a lighting device insert, in accordance with one embodiment of the present invention;

FIG. 3 is a diagram illustrating perspective internal view of an open enclosure for a lighting device insert, in accordance with one embodiment of the present invention;

FIG. 4 is a diagram illustrating side view of an open enclosure for a lighting device insert, in accordance with one embodiment of the present invention;

FIG. 5 is a diagram illustrating front view of an open enclosure for a lighting device insert, in accordance with one embodiment of the present invention;

FIG. 6 is a diagram illustrating rear view of an open enclosure for a lighting device insert, in accordance with one embodiment of the present invention;

FIG. 7 is a diagram illustrating top view of a closed enclosure for a lighting device insert, in accordance with one embodiment of the present invention;

FIG. 8 is a diagram illustrating bottom view of a closed enclosure for a lighting device insert, in accordance with one embodiment of the present invention;

FIG. 9 is a diagram illustrating perspective view of a closed enclosure for a lighting device insert, in accordance with one embodiment of the present invention;

FIG. 10 is a diagram illustrating side view of a closed enclosure for a lighting device insert, in accordance with one embodiment of the present invention;

FIG. 11 is a diagram illustrating front view of a closed enclosure for a lighting device insert, in accordance with one embodiment of the present invention; and

FIG. 12 is a diagram illustrating rear view of a closed enclosure for a lighting device insert, in accordance with one embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

In accordance with one embodiment of the present invention, an enclosure (100) for a lighting device insert is provided. The enclosure (100) for the lighting device insert may comprises of a body component (102) to accommodate the lighting device insert therein; a foldable tail component (104) to mount the enclosure (100) on a vehicle body; and a securing component (106) to secure the lighting device insert and the foldable tail component (104) therein.

In accordance with one embodiment of the present invention, the body component (102) may further comprise of an upper body component (108) and a lower body component (110) to accommodate the lighting device insert therein, wherein the upper body component (108) and lower body component (110) may be connected with each other on proximal end thorough a flexible joint (116). The upper body component (108) and lower body component (110) may be releasable connected with each other on distal end thorough the securing component (106). The upper body component (108) and lower body component (110) may further comprise of a plurality of openings (120) for a plurality of lighting components (124) of the lighting device insert. The lower body component (110) may further comprise of an opening (122) for an anchor (126) of the lighting device insert.

In accordance with one embodiment of the present invention, the foldable tail component (104) may be 180 degree foldable to mount the enclosure (100) on the vehicle body. The foldable tail component (104) may be connected with the body component (102) on proximal end with a pair of anchor (118) and secured with the securing component (106). The foldable tail component (104) may further comprise of a U shaped distal end to mount the enclosure (100) on the vehicle body. The foldable tail component (104) may be manufactured from silicon.

In accordance with one embodiment of the present invention, the securing component (106) may further comprise of a screw (112) and a nut (114) to secure the lighting device insert and the foldable tail component (104) therein.

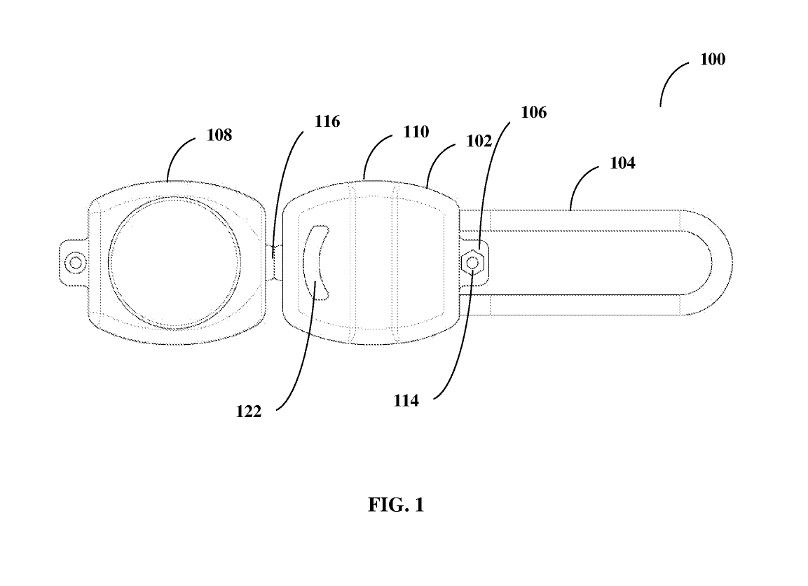

Referring to the FIG. 1 is a diagram illustrating top external view of an open enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 1) therein; the foldable tail component (104) to mount the enclosure (100) on the vehicle body (not shown in FIG. 1); and the securing component (106) to secure the lighting device insert and the foldable tail component (104) therein.

In accordance with one embodiment of the present invention, the body component (102) may further comprise of the upper body component (108) and the lower body component (110) to accommodate the lighting device insert (not shown in FIG. 1) therein. The upper body component (108) and the lower body component (110) may be 34.8 mm long, 32.2 mm wide, and 15.2 mm of thickness. The upper body component (108) and lower body component (110) may be connected with each other on proximal end thorough the flexible joint (116) of 7 mm. The upper body component (108) and lower body component (110) may be releasable connected with each other on distal end thorough the securing component (106) of 5.7 mm width. The upper body component (108) may have debossed area on its top to allow product logo which may be 25 mm in dimension. The lower body component (110) may further comprise of the opening (122) for the anchor (126) (not shown in FIG. 1) of the lighting device insert (not shown in FIG. 1). The body component (102) may be manufactured from material such as plastic or other similar materials. The anchor (126) (not shown in FIG. 1) of the lighting device insert (not shown in FIG. 1) may be used to hold the foldable tail component (104) when it may be wrapped around the vehicle body (not shown in FIG. 1) and affixed to the anchor (126) (not shown in FIG. 1) to mount the enclosure (100) on the vehicle body (not shown in FIG. 1).

In accordance with one embodiment of the present invention, the foldable tail component (104) may be 180 degree foldable to mount the enclosure (100) on the vehicle body (not shown in FIG. 1). The foldable tail component (104) may be 53.4 mm long and 20.6 mm wide, with thickness of 4 mm. The foldable tail component (104) may be connected with the body component (102) on proximal end with the pair of anchor (118) (not shown in FIG. 1) and secured with said securing component (106). The foldable tail component (104) may further comprise of the U shaped distal end to mount the enclosure (100) on the vehicle body (not shown in FIG. 1). The foldable tail component (104) may be manufactured from silicon or other similar materials. The foldable tail component (104) may be manufactured of varying colors.

In accordance with one embodiment of the present invention, the securing component (106) may further comprise of the screw (112) (not shown in FIG. 1) and the nut (114) to secure the lighting device insert (not shown in FIG. 1) and the foldable tail component (104) therein. The securing component (106) may be of 5.7 mm width.

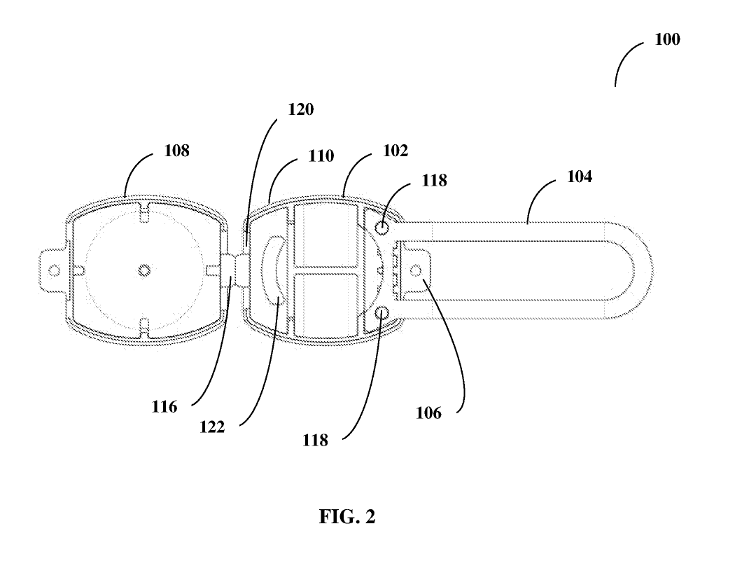

Referring to the FIG. 2 is a diagram illustrating top internal view of an open enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 2) therein; the foldable tail component (104) to mount the enclosure (100) on the vehicle body (not shown in FIG. 2); and the securing component (106) to secure the lighting device insert and the foldable tail component (104) therein.

In accordance with one embodiment of the present invention, the body component (102) may further comprise of the upper body component (108) and the lower body component (110) to accommodate the lighting device insert (not shown in FIG. 1) therein. The upper body component (108) and lower body component (110) may be connected with each other on proximal end thorough the flexible joint (116). The upper body component (108) and lower body component (110) may be releasable connected with each other on distal end thorough the securing component (106). The lower body component (110) may further comprise of the opening (122) for the anchor (126) (not shown in FIG. 2) of the lighting device insert (not shown in FIG. 2). The anchor (126) (not shown in FIG. 2) of the lighting device insert (not shown in FIG. 2) may be used to hold the foldable tail component (104) when it may be wrapped around the vehicle body (not shown in FIG. 2) and affixed to the anchor (126) (not shown in FIG. 2) to mount the enclosure (100) on the vehicle body (not shown in FIG. 2).

In accordance with one embodiment of the present invention, the foldable tail component (104) may be 180 degree foldable to mount the enclosure (100) on the vehicle body (not shown in FIG. 2). The foldable tail component (104) may be connected with the body component (102) on proximal end with the pair of anchor (118) and secured with said securing component (106). The foldable tail component (104) may further comprise of the U shaped distal end to mount the enclosure (100) on the vehicle body (not shown in FIG. 2).

In accordance with one embodiment of the present invention, the securing component (106) may further comprise of the screw (112) and the nut (114) (not shown in FIG. 2) to secure the lighting device insert (not shown in FIG. 2) and the foldable tail component (104) therein.

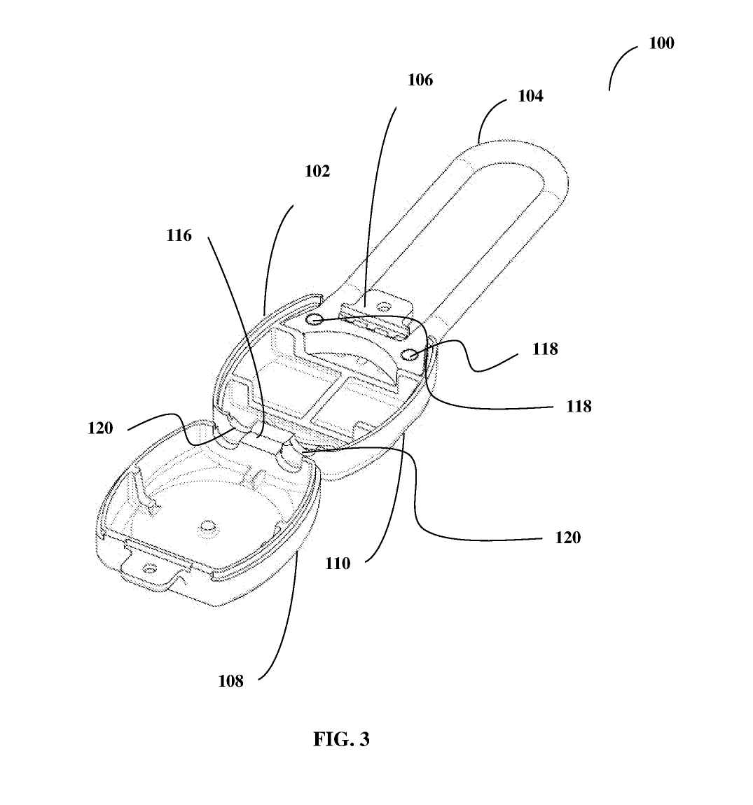

Referring to the FIG. 3 is a diagram illustrating perspective internal view of an open enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 3) therein; the foldable tail component (104) to mount the enclosure (100) on the vehicle body (not shown in FIG. 3); and the securing component (106) to secure the lighting device insert and the foldable tail component (104) therein.

In accordance with one embodiment of the present invention, the body component (102) may further comprise of the upper body component (108) and the lower body component (110) to accommodate the lighting device insert (not shown in FIG. 3) therein. The upper body component (108) and lower body component (110) may be connected with each other on proximal end thorough the flexible joint (116). The upper body component (108) and lower body component (110) may be releasable connected with each other on distal end thorough the securing component (106). The upper body component (108) and lower body component (110) may further comprise of the plurality of openings (120) for the plurality of lighting components (124) (not shown in FIG. 3) of the lighting device insert (not shown in FIG. 3), such as LEDs. The lower body component (110) may further comprise of the opening (122) for the anchor (126) (not shown in FIG. 3) of the lighting device insert (not shown in FIG. 3). The anchor (126) (not shown in FIG. 3) of the lighting device insert (not shown in FIG. 3) may be used to hold the foldable tail component (104) when it may be wrapped around the vehicle body (not shown in FIG. 3) and affixed to the anchor (126) (not shown in FIG. 3) to mount the enclosure (100) on the vehicle body (not shown in FIG. 3).

In accordance with one embodiment of the present invention, the foldable tail component (104) may be 180 degree foldable to mount the enclosure (100) on the vehicle body (not shown in FIG. 2). The foldable tail component (104) may be connected with the body component (102) on proximal end with the pair of anchor (118) and secured with said securing component (106). The foldable tail component (104) may further comprise of the U shaped distal end to mount the enclosure (100) on the vehicle body (not shown in FIG. 3).

In accordance with one embodiment of the present invention, the securing component (106) may further comprise of the screw (112) and the nut (114) (not shown in FIG. 3) to secure the lighting device insert (not shown in FIG. 3) and the foldable tail component (104) therein.

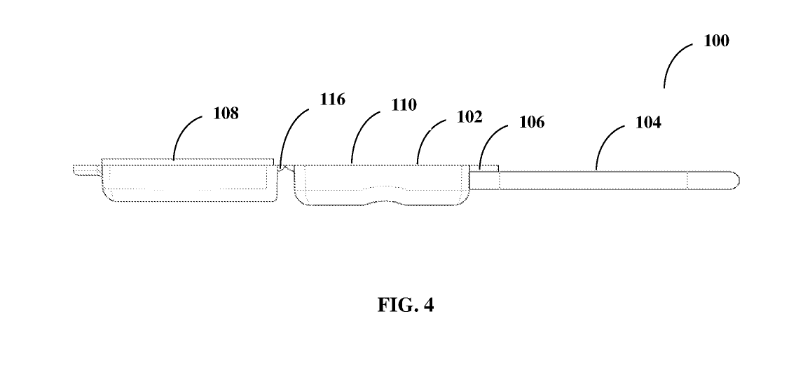

Referring to the FIG. 4 is a diagram illustrating side view of an open enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 4) therein; the foldable tail component (104) to mount the enclosure (100) on the vehicle body (not shown in FIG. 4); and the securing component (106) to secure the lighting device insert and the foldable tail component (104) therein.

In accordance with one embodiment of the present invention, the body component (102) may further comprise of the upper body component (108) and the lower body component (110) to accommodate the lighting device insert (not shown in FIG. 4) therein. The upper body component (108) and lower body component (110) may be connected with each other on proximal end thorough the flexible joint (116). The upper body component (108) and lower body component (110) may be releasable connected with each other on distal end thorough the securing component (106).

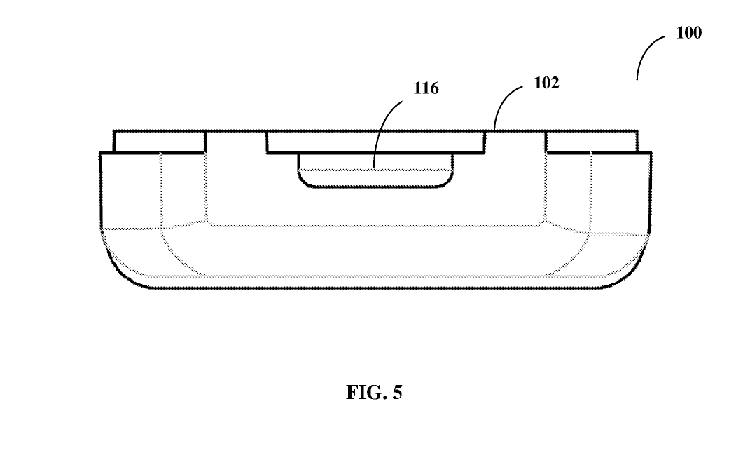

Referring to the FIG. 5 is a diagram illustrating front view of an open enclosure for a lighting device insert, in accordance with one embodiment of the present invention.

In accordance with one embodiment of the present invention, the enclosure (100) for the lighting device insert is provided. The enclosure (100) for the lighting device insert may comprise of the body component (102) to accommodate the lighting device insert (not shown in FIG. 5) therein. The body component (102) may further comprise of the upper body component (108) and the lower body component (110) connected with each other on proximal end thorough a flexible joint (116).

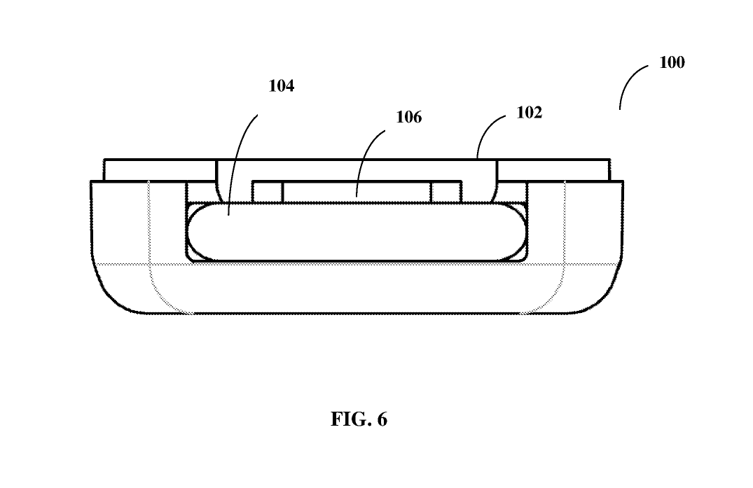

Referring to the FIG. 6 is a diagram illustrating rear view of an open enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 6) therein; the foldable tail component (104) to mount the enclosure (100) on the vehicle body (not shown in FIG. 6); and the securing component (106) to secure the lighting device insert and the foldable tail component (104) therein.

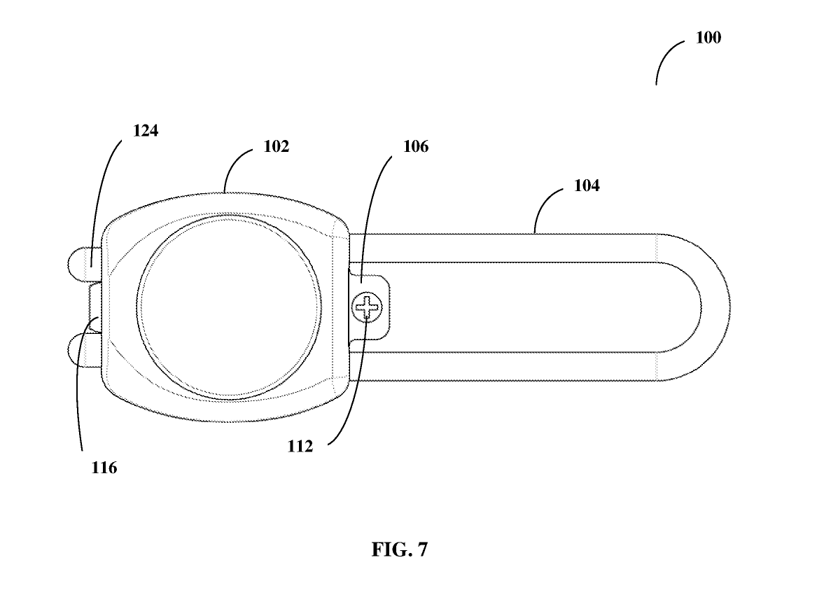

Referring to the FIG. 7 is a diagram illustrating top view of a closed enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 7) therein; the foldable tail component (104) to mount the enclosure (100) on the vehicle body (not shown in FIG. 7); and the securing component (106) to secure the lighting device insert and the foldable tail component (104) therein.

In accordance with one embodiment of the present invention, the body component (102) may further comprise of the upper body component (108) and the lower body component (110) to accommodate the lighting device insert (not shown in FIG. 7) therein. The upper body component (108) and lower body component (110) may be connected with each other on proximal end thorough the flexible joint (116). The upper body component (108) and lower body component (110) may be releasable connected with each other on distal end thorough the securing component (106). The upper body component (108) and the lower body component (110) further comprises of the plurality of openings (120) for the plurality of lighting components (124) of the lighting device insert.

In accordance with one embodiment of the present invention, the foldable tail component (104) may be 180 degree foldable to mount the enclosure (100) on the vehicle body (not shown in FIG. 7). The foldable tail component (104) may be connected with the body component (102) on proximal end with the pair of anchor (118) (not shown in FIG. 7) and secured with said securing component (106). The foldable tail component (104) may further comprise of the U shaped distal end to mount the enclosure (100) on the vehicle body (not shown in FIG. 7).

In accordance with one embodiment of the present invention, the securing component (106) may further comprise of the screw (112) and the nut (114) (not shown in FIG. 7) to secure the lighting device insert (not shown in FIG. 7) and the foldable tail component (104) therein.

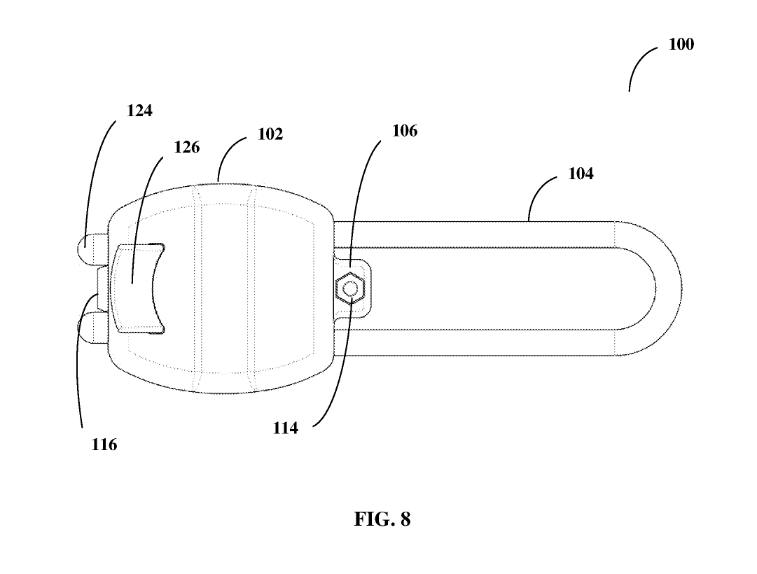

Referring to the FIG. 8 is a diagram illustrating bottom view of a closed enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 8) therein; the foldable tail component (104) to mount the enclosure (100) on the vehicle body (not shown in FIG. 8); and the securing component (106) to secure the lighting device insert and the foldable tail component (104) therein.

In accordance with one embodiment of the present invention, the body component (102) may further comprise of the upper body component (108) and the lower body component (110) to accommodate the lighting device insert therein. The upper body component (108) and lower body component (110) may be connected with each other on proximal end thorough the flexible joint (116). The upper body component (108) and lower body component (110) may be releasable connected with each other on distal end thorough the securing component (106). The upper body component (108) and the lower body component (110) further comprises of the plurality of openings (120) for the plurality of lighting components (124) of the lighting device insert. The lower body component (110) may further comprise of the opening (122) for the anchor (126) of the lighting device insert. The anchor (126) of the lighting device insert may be used to hold the foldable tail component (104) when it may be wrapped around the vehicle body (not shown in FIG. 8) and affixed to the anchor (126) to mount the enclosure (100) on the vehicle body (not shown in FIG. 8).

In accordance with one embodiment of the present invention, the foldable tail component (104) may be 180 degree foldable to mount the enclosure (100) on the vehicle body (not shown in FIG. 8). The foldable tail component (104) may further comprise of the U shaped distal end to mount the enclosure (100) on the vehicle body (not shown in FIG. 8).

In accordance with one embodiment of the present invention, the securing component (106) may further comprise of the screw (112) (not shown in FIG. 8) and the nut (114) to secure the lighting device insert (not shown in FIG. 8) and the foldable tail component (104) therein.

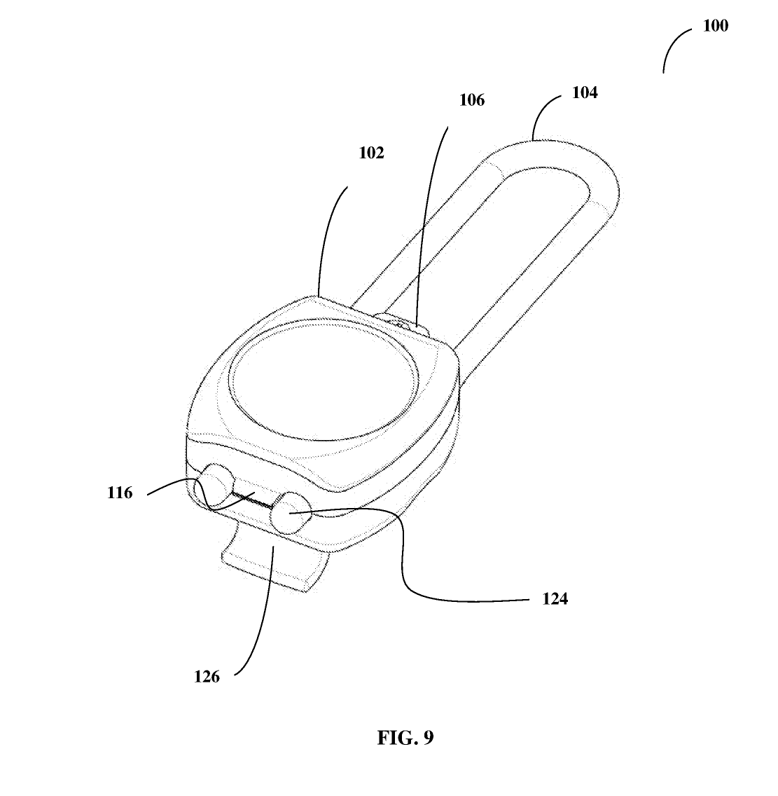

Referring to the FIG. 9 is a diagram illustrating perspective view of a closed enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 9) therein; the foldable tail component (104) to mount the enclosure (100) on the vehicle body (not shown in FIG. 9); and the securing component (106) to secure the lighting device insert and the foldable tail component (104) therein.

In accordance with one embodiment of the present invention, the body component (102) may further comprise of the upper body component (108) and the lower body component (110) to accommodate the lighting device insert therein. The upper body component (108) and lower body component (110) may be connected with each other on proximal end thorough the flexible joint (116). The upper body component (108) and lower body component (110) may be releasable connected with each other on distal end thorough the securing component (106). The upper body component (108) and the lower body component (110) further comprises of the plurality of openings (120) for the plurality of lighting components (124) of the lighting device insert. The lower body component (110) may further comprise of the opening (122) for the anchor (126) of the lighting device insert.

In accordance with one embodiment of the present invention, the foldable tail component (104) may be 180 degree foldable to mount the enclosure (100) on the vehicle body (not shown in FIG. 9). The foldable tail component (104) may further comprise of the U shaped distal end to mount the enclosure (100) on the vehicle body (not shown in FIG. 9).

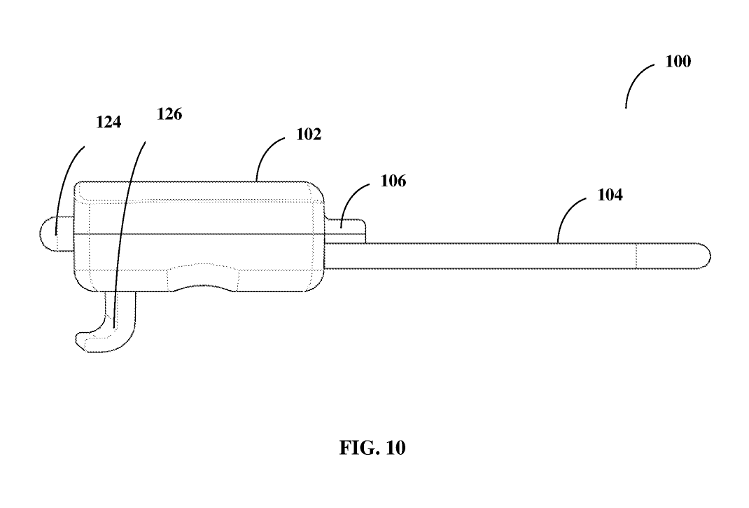

Referring to the FIG. 10 is a diagram illustrating side view of a closed enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert (not shown in FIG. 10) therein; the foldable tail component (104) to mount the enclosure (100) on the vehicle body (not shown in FIG. 10); and the securing component (106) to secure the lighting device insert and the foldable tail component (104) therein. The upper body component (108) and the lower body component (110) of the body component (102) further comprises of the plurality of openings (120) (not shown in FIG. 10) for the plurality of lighting components (124) of the lighting device insert. The lower body component (110) of the body component (102) may further comprise of the opening (122) (not shown in FIG. 10) for the anchor (126) of the lighting device insert.

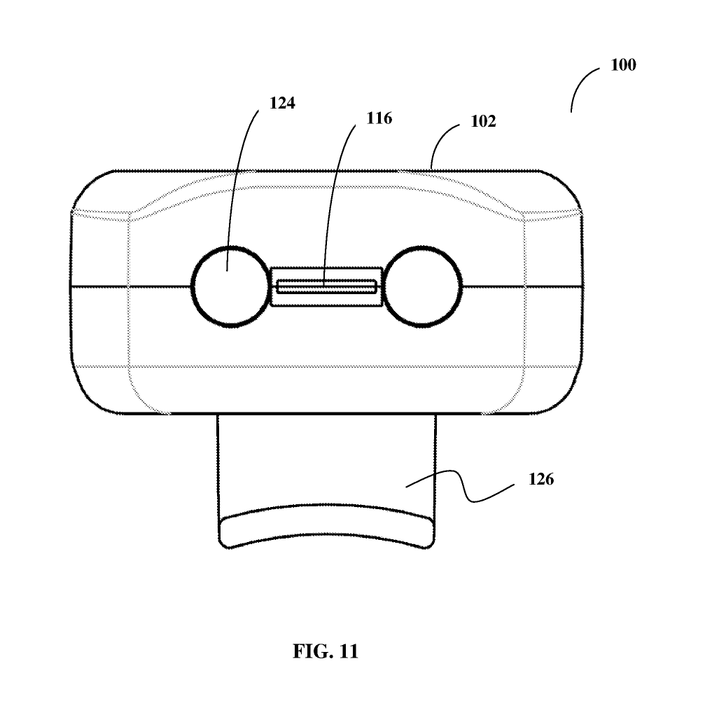

Referring to the FIG. 11 is a diagram illustrating front view of a closed enclosure for a lighting device insert, in accordance with one embodiment of the present invention.

In accordance with one embodiment of the present invention, the enclosure (100) for the lighting device insert is provided. The enclosure (100) for the lighting device insert may comprise of the body component (102) to accommodate the lighting device insert therein. The body component (102) may further comprise of the upper body component (108) and the lower body component (110) connected with each other on proximal end thorough a flexible joint (116). The upper body component (108) and the lower body component (110) further comprises of the plurality of openings (120) for the plurality of lighting components (124) of the lighting device insert. The lower body component (110) of the body component (102) may further comprise of the opening (122) (not shown in FIG. 11) for the anchor (126) of the lighting device insert.

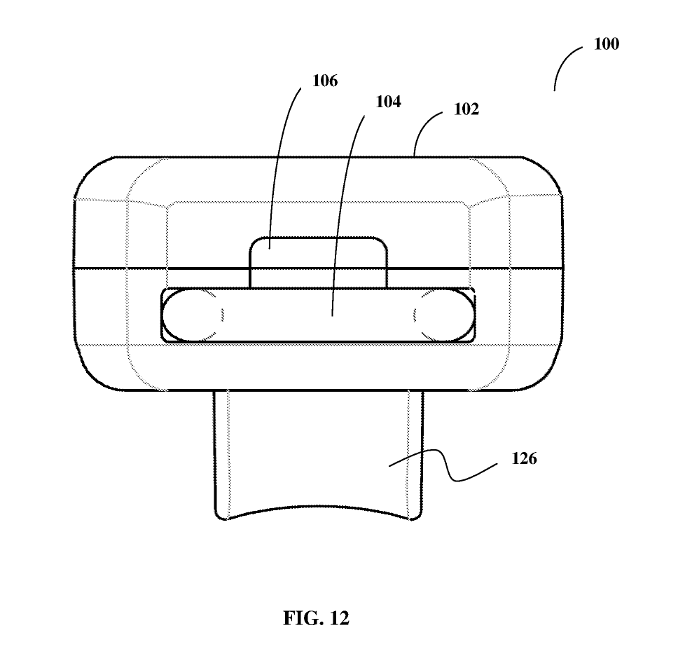

Referring to the FIG. 12 is a diagram illustrating rear view of a closed enclosure for a lighting device insert, in accordance with one embodiment of the present invention.

In accordance with one embodiment of the present invention, the enclosure (100) for the lighting device insert is provided. The enclosure (100) for the lighting device insert may comprises of the body component (102) to accommodate the lighting device insert therein; the foldable tail component (104) to mount the enclosure (100) on the vehicle body (not shown in FIG. 12); and the securing component (106) to secure the lighting device insert and the foldable tail component (104) therein. The lower body component (110) of the body component (102) may further comprise of the opening (122) (not shown in FIG. 12) for the anchor (126) of the lighting device insert.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

What is claimed is:

1. An enclosure (100) for a lighting device insert; wherein said enclosure (100) for said lighting device insert comprises of:
a. a body component (102) to accommodate said lighting device insert therein;
b. a foldable tail component (104) to mount said enclosure (100) on a vehicle body; and
c. a securing component (106) to secure said lighting device insert and said foldable tail component (104) therein.

2. The enclosure (100) as claimed in claim 1, wherein said body component (102) further comprises of an upper body component (108) and a lower body component (110) to accommodate said lighting device insert therein.

3. The enclosure (100) as claimed in claim 2, wherein said upper body component (108) and lower body component (110) are connected with each other on proximal end thorough a flexible joint (116).

4. The enclosure (100) as claimed in claim 2, wherein said upper body component (108) and lower body component (110) are releasable connected with each other on distal end thorough said securing component (106).

5. The enclosure (100) as claimed in claim 2, wherein said upper body component (108) and lower body component (110) further comprises of a plurality of openings (120) for a plurality of lighting components (124) of said lighting device insert.

6. The enclosure (100) as claimed in claim 2, wherein said lower body component (110) further comprises of an opening (122) for an anchor (126) of said lighting device insert.

7. The enclosure (100) as claimed in claim 1, wherein said foldable tail component (104) is 180 degree foldable to mount said enclosure (100) on said vehicle body.

8. The enclosure (100) as claimed in claim 1, wherein said foldable tail component (104) is connected with said body component (102) on proximal end with a pair of anchor (118) and secured with said securing component (106)

9. The enclosure (100) as claimed in claim 1, wherein said foldable tail component (104) further comprises of a U shaped distal end to mount said enclosure (100) on said vehicle body.

10. The enclosure (100) as claimed in claim 1, wherein said foldable tail component (104) is manufactured from silicon.

11. The enclosure (100) as claimed in claim 1, wherein said securing component (106) further comprises of a screw (112) and a nut (114) to secure said lighting device insert and said foldable tail component (104) therein.
